(19) United States
(12) Patent Application Publication
(10) Pub. No.: US 2026/0278400 A1
(43) Pub. Date: Sep. 17, 2026

(54) APPARATUS, METHOD, AND SYSTEM FOR MACHINE LEARNING JOB CHECKPOINTING IN TRUSTLESS DISTRIBUTED TRAINING PLATFORMS

(71) Applicant: Nokia Solutions and Networks Oy, Espoo (FI)

(72) Inventors: Novak BOSKOV, Stuttgart (DE); Manzoor KHAN, Murray Hill, NJ (US); Thomas WOO, Murray Hill, NJ (US); Thomas WILLIAMS, Columbus, OH (US); Bart THEETEN, Antwerp (BE)

(21) Appl. No.: 19/544,500

(22) Filed: Feb. 19, 2026

Related U.S. Application Data
(60) Provisional application No. 63/771,797, filed on Mar. 14, 2025.

(51) Int. Cl. G06N 3/0985; G06N 3/10

(52) U.S. Cl. CPC G06N 3/0985; G06N 3/10

(57) ABSTRACT

An approach is provided for Machine Learning (ML) job checkpointing in trustless distributed training platforms. The approach, for example, involves receiving an abort message from a resource owner system. The abort message relates to a ML training job that is running. The approach also involves receiving a checkpoint claim from the resource owner system based on the cancelling of the ML training job. The approach further involves receiving a proof of the checkpoint claim comprising at least one of: a proof of execution of the ML training job generated within a Trusted Execution Environment (TEE); or a creation of a future restore failure transaction on a Distributed Ledger Technology (DLT) network configured to execute under a dispute protocol concerning a validity of the checkpoint claim. The approach further involves causing, at least in part, a storage of training artifacts of the ML training job based on the proof.

### FIELD

The disclosed subject matter generally relates to checkpointing which is the process of saving and restoring the state of a Machine Learning (ML) model.

### BACKGROUND

The state of a Machine Learning (ML) model typically consists of its weights, hyperparameters, and progress indicators. The training process consumes the training data and modifies the model weights to minimize a particular loss function, effectively changing the model's state. As the training typically happens in batches of training data, after which the model weights get updated, the checkpointing process can store the weight values after each batch has taken effect and restore the model's state at some future time. To reduce the training time, checkpointing typically happens after some number of batches and not after each one.

However, when the training occurs in a decentralized system, there may be no explicit trust between the ML job owner and the ML training resource provider (e.g., a trustless distributed ML training platform). The trustless distributed settings of this decentralized system create significant technical challenges and constraints on batch-based ML training and checkpointing. These technical challenges and constraints include the following: (1) the resource provider that stores the checkpoint is often unrelated and disconnected from the provider that will restore the checkpoint; (2) resource providers and job owners may stand in the position of market competitors; and (3) both the job owner and resource provider should protect themselves against losses incurred by the misbehavior of the other party.

### SOME EXAMPLE EMBODIMENTS

Therefore, there is a need for providing Machine Learning (ML) job checkpointing in trustless distributed training platforms.

According to one example embodiment, an apparatus comprises means for receiving an abort message from a resource owner system, the abort message relating to cancelling a ML training job that is running, and the resource owner system providing at least one compute resource for performing the ML training job. The apparatus also comprises means for receiving a checkpoint claim from the resource owner system, the checkpoint claim relating to a checkpointing of the ML training job based on the cancelling of the ML training job. The apparatus further comprises means for receiving a proof of the checkpoint claim from the resource owner system, the proof comprising at least one of: a proof of execution of the ML training job generated within a Trusted Execution Environment (TEE); or a creation of a future restore failure transaction on a Distributed Ledger Technology (DLT) network, the future restore failure transaction configured to execute under a dispute protocol concerning a validity of the checkpoint claim. The apparatus further comprises means for causing, at least in part, a storage of training artifacts of the ML training job based on the proof.

According to another embodiment, an apparatus comprises at least one processor, and at least one memory storing instructions that, when executed by the at least one processor, cause the apparatus at least to perform receiving an abort message from a resource owner system, the abort message relating to cancelling a ML training job that is running, and the resource owner system providing at least one compute resource for performing the ML training job. The apparatus is also caused to perform receiving a checkpoint claim from the resource owner system, the checkpoint claim relating to a checkpointing of the ML training job based on the cancelling of the ML training job. The apparatus is further caused to perform receiving a proof of the checkpoint claim from the resource owner system, the proof comprising at least one of: a proof of execution of the ML training job generated within a TEE; or a creation of a future restore failure transaction on a DLT network, the future restore failure transaction configured to execute under a dispute protocol concerning a validity of the checkpoint claim. The apparatus further causes, at least in part, a storage of training artifacts of the ML training job based on the proof.

According to another embodiment, a method comprises receiving an abort message from a resource owner system, the abort message relating to cancelling a ML training job that is running, and the resource owner system providing at least one compute resource for performing the ML training job. The method also comprises receiving a checkpoint claim from the resource owner system, the checkpoint claim relating to a checkpointing of the ML training job based on the cancelling of the ML training job. The method further comprises receiving a proof of the checkpoint claim from the resource owner system, the proof comprising at least one of: a proof of execution of the ML training job generated within a TEE; or a creation of a future restore failure transaction on a DLT network, the future restore failure transaction configured to execute under a dispute protocol concerning a validity of the checkpoint claim. The method further comprises causing, at least in part, a storage of training artifacts of the ML training job based on the proof.

According to another embodiment, a computer program comprises instructions which, when executed by an apparatus, cause the apparatus to perform receiving an abort message from a resource owner system, the abort message relating to cancelling a ML training job that is running, and the resource owner system providing at least one compute resource for performing the ML training job. The apparatus is also caused to perform receiving a checkpoint claim from the resource owner system, the checkpoint claim relating to a checkpointing of the ML training job based on the cancelling of the ML training job. The apparatus is further caused to perform receiving a proof of the checkpoint claim from the resource owner system, the proof comprising at least one of: a proof of execution of the ML training job generated within a TEE; or a creation of a future restore failure transaction on a DLT network, the future restore failure transaction configured to execute under a dispute protocol concerning a validity of the checkpoint claim. The apparatus further causes, at least in part, a storage of training artifacts of the ML training job based on the proof.

According to one example embodiment, an apparatus comprises means for initiating a restoration of a ML training job, the ML training job being previously aborted by a first resource owner system. The apparatus also comprises means for causing, at least in part, a transmission of a checkpoint claim created by the first resource owner system to a second resource owner system, the checkpoint claim being associated with a proof comprising at least on of: a proof of execution of the ML training job up to a progress pointer in a training dataset, the proof of execution generated within a TEE of the first resource owner system; or a creation of a future restore failure transaction on a DLT network, the future restore failure transaction configured to execute under a dispute protocol concerning a validity of the checkpoint claim. The apparatus further comprises means for facilitating an access of the second resource owner to training artifacts associated with the checkpoint claim. The restoration of the ML training job is initiated based on the training artifacts and the progress pointer.

According to another embodiment, an apparatus comprises at least one processor, and at least one memory storing instructions that, when executed by the at least one processor, cause the apparatus at least to perform initiating a restoration of a ML training job, the ML training job being previously aborted by a first resource owner system. The apparatus also comprises means for causing, at least in part, a transmission of a checkpoint claim created by the first resource owner system to a second resource owner system, the checkpoint claim being associated with a proof comprising at least on of: a proof of execution of the ML training job up to a progress pointer in a training dataset, the proof of execution generated within a TEE of the first resource owner system; or a creation of a future restore failure transaction on a DLT network, the future restore failure transaction configured to execute under a dispute protocol concerning a validity of the checkpoint claim. The apparatus further comprises means for facilitating an access of the second resource owner to training artifacts associated with the checkpoint claim. The restoration of the ML training job is initiated based on the training artifacts and the progress pointer.

According to another embodiment, a method comprises initiating a restoration of a ML training job, the ML training job being previously aborted by a first resource owner system. The method also comprises causing, at least in part, a transmission of a checkpoint claim created by the first resource owner system to a second resource owner system, the checkpoint claim being associated with a proof comprising at least on of: a proof of execution of the ML training job up to a progress pointer in a training dataset, the proof of execution generated within a TEE of the first resource owner system; or a creation of a future restore failure transaction on a DLT network, the future restore failure transaction configured to execute under a dispute protocol concerning a validity of the checkpoint claim. The method further comprises means for facilitating an access of the second resource owner to training artifacts associated with the checkpoint claim. The restoration of the ML training job is initiated based on the training artifacts and the progress pointer.

According to another embodiment, a computer program comprises instructions which, when executed by an apparatus, cause the apparatus to perform initiating a restoration of a ML training job, the ML training job being previously aborted by a first resource owner system. The apparatus also comprises means for causing, at least in part, a transmission of a checkpoint claim created by the first resource owner system to a second resource owner system, the checkpoint claim being associated with a proof comprising at least on of: a proof of execution of the ML training job up to a progress pointer in a training dataset, the proof of execution generated within a TEE of the first resource owner system; or a creation of a future restore failure transaction on a DLT network, the future restore failure transaction configured to execute under a dispute protocol concerning a validity of the checkpoint claim. The apparatus further comprises means for facilitating an access of the second resource owner to training artifacts associated with the checkpoint claim. The restoration of the ML training job is initiated based on the training artifacts and the progress pointer.

According to one example embodiment, an apparatus comprises means for generating a checkpoint claim, wherein the checkpoint claim relates a checkpointing of a ML training job that is running. The apparatus also comprises means for generating a proof of the checkpoint claim, the proof comprising at least one of: a proof of execution of the ML training job generated within a Trusted Execution Environment TEE; or a creation of a future restore failure transaction on a DLT network, the future restore failure transaction configured to execute under a dispute protocol concerning a validity of the checkpoint claim. The apparatus further comprises means for causing, at least in part, a transmission of the proof of the checkpoint claim.

According to another embodiment, an apparatus comprises at least one processor, and at least one memory storing instructions that, when executed by the at least one processor, cause the apparatus at least to perform generating a checkpoint claim, wherein the checkpoint claim relates a checkpointing of a ML training job that is running. The apparatus is also caused to perform generating a proof of the checkpoint claim, the proof comprising at least one of: a proof of execution of the ML training job generated within a Trusted Execution Environment TEE; or a creation of a future restore failure transaction on a DLT network, the future restore failure transaction configured to execute under a dispute protocol concerning a validity of the checkpoint claim. The apparatus is further caused to perform causing, at least in part, a transmission of the proof of the checkpoint claim.

According to another embodiment, a method comprises generating a checkpoint claim, wherein the checkpoint claim relates a checkpointing of a ML training job that is running. The method also comprises generating a proof of the checkpoint claim, the proof comprising at least one of: a proof of execution of the ML training job generated within a Trusted Execution Environment TEE; or a creation of a future restore failure transaction on a DLT network, the future restore failure transaction configured to execute under a dispute protocol concerning a validity of the checkpoint claim. The method further comprises causing, at least in part, a transmission of the proof of the checkpoint claim.

According to another embodiment, a computer program comprises instructions which, when executed by an apparatus, cause the apparatus to perform generating a checkpoint claim. The checkpoint claim relates a checkpointing of a ML training job that is running. The apparatus is also caused to perform generating a proof of the checkpoint claim, the proof comprising at least one of: a proof of execution of the ML training job generated within a Trusted Execution Environment TEE; or a creation of a future restore failure transaction on a DLT network, the future restore failure transaction configured to execute under a dispute protocol concerning a validity of the checkpoint claim. The apparatus is further caused to perform causing, at least in part, a transmission of the proof of the checkpoint claim.

According to one example embodiment, an apparatus comprises means for receiving a checkpoint claim. The checkpoint claim relates a checkpointing of a ML training job that is running. The apparatus also comprises means for receiving a proof of the checkpoint claim, the proof comprising at least one of: a proof of execution of the ML training job generated within a Trusted Execution Environment TEE; or a creation of a future restore failure transaction on a DLT network, the future restore failure transaction configured to execute under a dispute protocol concerning a validity of the checkpoint claim. The apparatus further comprises means for causing, at least in part, a verification of the proof of the checkpoint claim.

According to another embodiment, an apparatus comprises at least one processor, and at least one memory storing instructions that, when executed by the at least one processor, cause the apparatus at least to perform receiving a checkpoint claim. The checkpoint claim relates a checkpointing of a ML training job that is running. The apparatus is also caused to perform receiving a proof of the checkpoint claim, the proof comprising at least one of: a proof of execution of the ML training job generated within a Trusted Execution Environment TEE; or a creation of a future restore failure transaction on a DLT network, the future restore failure transaction configured to execute under a dispute protocol concerning a validity of the checkpoint claim. The apparatus is further caused to perform causing, at least in part, a verification of the proof of the checkpoint claim.

According to another embodiment, a method comprises receiving a checkpoint claim. The checkpoint claim relates a checkpointing of a ML training job that is running. The method also comprises receiving a proof of the checkpoint claim, the proof comprising at least one of: a proof of execution of the ML training job generated within a Trusted Execution Environment TEE; or a creation of a future restore failure transaction on a DLT network, the future restore failure transaction configured to execute under a dispute protocol concerning a validity of the checkpoint claim. The method further comprises causing, at least in part, a verification of the proof of the checkpoint claim.

According to another embodiment, a computer program comprises instructions which, when executed by an apparatus, cause the apparatus to perform receiving a checkpoint claim. The checkpoint claim relates a checkpointing of a ML training job that is running. The apparatus is also caused to perform receiving a proof of the checkpoint claim, the proof comprising at least one of: a proof of execution of the ML training job generated within a Trusted Execution Environment TEE; or a creation of a future restore failure transaction on a DLT network, the future restore failure transaction configured to execute under a dispute protocol concerning a validity of the checkpoint claim. The apparatus is further caused to perform causing, at least in part, a verification of the proof of the checkpoint claim.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

According to some aspects, there is provided the subject matter of the independent claims. Some further aspects are defined in the dependent claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The example embodiments of the invention are illustrated by way of examples, and not by way of limitation, in the figures of the accompanying drawings:

FIG. 1 is a diagram of a system capable of providing Machine Learning (ML) job checkpointing in trustless distributed training platforms, according to one example embodiment;

FIG. 2 is a flowchart of an abort protocol for providing ML job checkpointing in trustless distributed training platforms, according to one example embodiment;

FIG. 3 is a flowchart of a restore protocol for providing ML job checkpointing in trustless distributed training platforms, according to one example embodiment;

FIG. 4 is a sequence diagram for an abort protocol using a Trusted Execution Environment (TEE), according to one example embodiment;

FIG. 5 is a signaling diagram for an abort protocol not using a TEE, according to one example embodiment;

FIG. 6 is a signaling diagram for a restore protocol, according to one example embodiment;

FIG. 7 is a diagram of hardware that can be used to implement example embodiments; and

FIG. 8 is a diagram of a chip set that can be used to implement example embodiments.

### DESCRIPTION OF SOME EMBODIMENTS

Examples of a method, apparatus, and computer program for providing Machine Learning (ML) job checkpointing in trustless distributed training platforms, according to one example embodiment, are disclosed in the following. In the following description, for the purposes of explanation, numerous specific details and examples are set forth to provide a thorough understanding of the embodiments of the invention. It is apparent, however, to one skilled in the art that the embodiments of the invention may be practiced without these specific details or with an equivalent arrangement. In other instances, structures and devices are shown in block diagram form to avoid unnecessarily obscuring the embodiments of the invention.

Reference in this specification to “one embodiment”, “one example embodiment”, “an “embodiment”, or “an example embodiment” means that a particular feature, structure, or characteristic described in connection with the embodiment is included in at least one embodiment of the present disclosure. The appearance of the phrase “in one embodiment” or “in one example embodiment” in various places in the specification are not necessarily all referring to the same example embodiment, nor are separate or alternative example embodiments mutually exclusive of other embodiments. In addition, the embodiments described herein are provided by example, and as such, “one embodiment” can also be used synonymously as “one example embodiment.” Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

As used herein, “at least one of the following: <a list of two or more elements>,” “at least one of<a list of two or more elements>,” “<a list of two or more elements>or a combination thereof,” and similar wording, where the list of two or more elements are joined by “and” or “or”, mean at least any one of the elements, or at least any two or more of the elements, or at least all the elements.

As used herein, the term “cancelling” refers to pausing a ML training job by, for instance, stopping the training process temporarily while preserving the current state of the ML model (e.g., by “checkpointing”). In addition, a used herein a “restore failure” means that the process of resuming the training of a ML job from a previously saved state or checkpoint has encountered an error or issue.

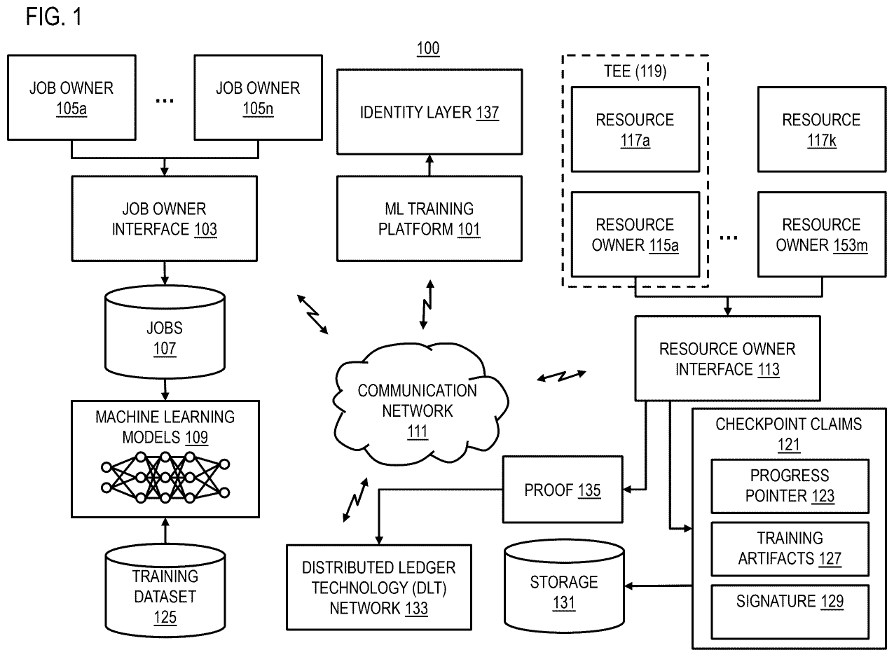

FIG. 1 is a diagram of a system capable of providing ML job checkpointing in trustless distributed training platforms, according to one example embodiment. Checkpointing in ML training refers to the process of saving the current state of a model, including its model weights, hyperparameters, and related information at specific intervals (e.g., after each batch of a training dataset). Conventional checkpointing processes generally use centralized systems where the ML training job owner trusts the resource (e.g., graphics processing unit (GPU), neural processing unit (NPU), central processing unit (CPU), etc.) owner/provider and where the resources owner can always access the checkpoint data. Trust, for instance, refers to explicit trust comprising predefined and deliberate agreements between different systems involved in the ML training pipeline (e.g., systems of the job owner and the resource owner). For example, to establish an explicit trust relationship between systems in ML training, the participating systems or parties can authenticate and authorize each other using secure credentials, such as but not limited to application programming interface (API) keys, OAuth tokens, mutual certificates (e.g., transport layer security (TLS) certificates), and/or equivalent. Because centralized systems generally operate under a central authority or single point of control, thereby making it easier for the central authority to regulate explicit trust relationships among participating systems.

In contrast, distributed and decentralized ML training platforms (e.g., ML training platform 101) generally are trustless with no explicit trust between participating parties. As shown in the example of FIG. 1, distributed and decentralized machine learning platforms can consist of three components:
(1) The job owner interface 103: a system that offers job owners 105a-105n (also collectively referred to as job owners 105) the ability to upload their jobs 107 (e.g., ML training job) over a communication network 111 and bid/request for the resources that they lack to perform the job 107. As used herein, references to job owners 105 include synonymous references to systems associated with the job owners 105. By way of example, a job 107 comprises a process of training a ML model 109 (e.g., a neural network) by feeding it training data and adjusting its model weights and hyperparameters to minimize a specific loss function. As used herein, model weights are learned by the model during the training process. They define the structure of the ML model 109 in terms of weights and biases. For example, in a neural network, each neuron has a weight associated with its connections to other neurons. These weights determine how much influence an input has on the final output. As previously described, the training process involves adjusting these weights to minimize a particular loss function, effectively changing the ML model 109's state. Hyperparameters, for instance, are external settings (with respect to the ML model 109) configured before training begins that control how the model learns. Unlike model weights, hyperparameters are not learned from data but are manually set and tuned to optimize model performance. Examples of hyperparameters include the learning rate, the number of hidden layers and neurons in a neural network, batch size, etc.
(2) The resource owner interface 113: a system that helps resource owners 115a-115m (also collectively referred to as resource owners 115) with idle resources 117a-117k (also collectively referred to as resources 117) to utilize them for the benefit of using those resources 117 to perform the jobs 107 of job owners 105. As used herein, references to resource owners 115 synonymously include references to systems associated with the resource owners 115. By way of example, resources 117 refer to the computational assets used to perform the jobs 107 (e.g., ML training jobs). These include hardware components such as CPUs, GPUs, tensor processing units (TPUs), etc., which provide the processing power to handle large training datasets and complex learning algorithms. Additionally, resources 117 can encompass memory and storage systems used to store training datasets, model weights, hyperparameters, and/or any other data used or generated during the ML training process (e.g., job 107). In some embodiments, the resource owner 115 can operate the resource within a Trusted Execution Environment (TEE) 119 or equivalent. By way of example, a TEE 119 (e.g., AMD Trust Zone, Intel SGX, or NVIDIA Confidential Computing, and/or equivalent) is a secure area within a resource 117 (e.g., processing resource) that ensures the confidentiality and integrity of the code and data loaded inside it. The TEE 119, for instance, provides attestation mechanisms to verify the integrity of ML models and related training data so that jobs 107 can be executed in isolated, hardware-protected compute environments.
(3) The ML training platform 101: a decentralized application or system that ensures tracking, execution, verification, etc. of the ML training jobs 107 by the resource owners 115 for the job owners 105.

The job owners 105 and resource owners 115 often are direct competitors within the ML space. For example, job owners 105 can become resource owners 115 when they have excess compute capacity when not completing their own jobs 107; and resource owners 115 can become job owners 105 when they have jobs 107 that require extra compute resources. Because of this competitive relationship and because the system 100 is a trustless distributed ML training platform, there could be incentives or opportunities for either job owners 105 or resource owners to act maliciously or fraudulently when completing ML training jobs 107. Therefore, there are significant technical challenges with respect to protecting both the job owner 105 and resource owner 115 against the potential misbehavior of the other party when performing ML jobs 107, particularly when checkpointing such jobs 107 for later restoration. Potential consequences of such behavior can include failure to restore checkpointed jobs 107. This in turn can lead to wasting additional compute resources to repeat all or a portion of the training of a ML model 109.

ML training is a low-level feature of modern ML frameworks such as PyTorch. As posited above, the checkpoint process is primarily designed for local and trustful load-store workflows. The party checkpointing the training process trusts the one who restores the checkpoint. As noted above, the problem of ML training checkpoints in trustless settings, where the party that checkpoints the training process may have palpable interest in lying about the process to gain direct financial benefits, present significant technical challenges.

With the recent proliferation of large language models, distributed and decentralized machine learning such as but not limited to fetch.ai, Ocean Protocol, Akash Network, Nokia Bell Labs OurAI, and/or the like are becoming increasingly relevant. Therefore, scenarios when the job owners 105 outsource their jobs 107 to external compute infrastructure (e.g., resources 117) controlled by their competitors (e.g., resource owners 115) are becoming increasingly common. This exacerbates the problem of ensuring valid checkpointing of ML training jobs 107 when those jobs 107 are performed in a trustless distributed environment.

To address these technical challenges, the system 100 of the FIG. 1 introduces a capability to provide valid ML training checkpoints in ML platforms that do not explicitly assume trust among the parties.

In one embodiment, the elements of an ML (e.g., neural network) training checkpoint claim 121 include: (1) a progress pointer 123 in the training dataset 125, e.g., containing the location of the last processed datum in the training dataset used to train the ML model 109 before checkpointing; and (2) training artifacts 127, including model weights and hyperparameters corresponding to the training up to the claimed progress pointer.

In one embodiment, the checkpoint claim 121 can optionally include a the resource owner signature 129. The resource owner signature 129, for instance, is a cryptographic signature that binds the resource owner 115 to their checkpoint claim 121. A cryptographic signature, for instance, is a mathematical scheme used to verify the authenticity and integrity of checkpoint claim 121. It can employ asymmetric cryptography or equivalent, where a private key is used to sign the data, and a corresponding public key is used to verify the signature.

In some embodiments, as the job owner 105 is the one who created the job 107 and pointed the resource owner 115 to the training dataset 125, the training dataset 125 itself need not be included in the checkpoint claim 121. In this case, the next resource owner 115 that restores the job 107 from the checkpoint claim 121 can also be pointed to the same training dataset 125 to reduce the size and corresponding memory resource requirements for storing the training dataset 125 in the checkpoint claim 121 (e.g., in the storage 131). assume that the training data itself may not be included in the checkpoint. However, it is contemplated that in embodiments where the original location of the training dataset 125 may not be available or otherwise not accessible for restoration of the job 107, the training dataset 125 can be included in the checkpoint claim 121.

At the time of cancelling the running job 107, the resource owner 115 (e.g., resource provider) and the job owner 105 should agree on the checkpoint such that either or both parties accept the checkpoint or reject it. In a trustless environment, the job owner 105 generally cannot blindly accept an arbitrary checkpoint claim 121 of the resource owner 115 due to the lack of explicit trust between the two parties. In other words, the problem of checkpointing ML model (e.g., neural network) training is defined as follows: given an untrusted resource owner 115 and their checkpoint claim 121, create a protocol to assure the restoration of the checkpoint at a future time and in a different place.

A naïve solution would require the job owner 105 to re-run the job 107 up to the claimed checkpoint and compare the training artifacts 127 received from the resource owner 115 with the obtained results. However, this solution can be impractical as the job owner 105 has no capabilities to execute the job 107 itself, which is the reason for the job owner 105 to use the ML training platform 101 to offload the job 107 in the first place. A more practical solution, such as the one presented in the various embodiments described herein ensures the following properties:
(1) Universal checkpoint recoverability: The ability to restore the checkpoint must not be constrained to the resource owner 115 that produced the checkpoint (i.e., the cancelling provider). The cancelling provider must prove that they made all necessary training artifacts 127 available to any capable resource owner 115 registered to the ML training platform 101. This feature assures the platform 101's availability, as the job owner 105 should have the flexibility to seamlessly transfer jobs 107 among resource owners 115 in a timely and secure manner. On the other hand, the resource owners 115 should maintain their own flexibility to drop third-party jobs 107 in the event of bursty workloads on their own side.
(2) Independent verification: The job owner 105 should be able to independently verify the validity of the checkpoint claim 121 without reevaluating the job 107 itself. In doing so, the job owner 105 may have access to infrastructural components of the system 100. For instance, the job owner 105 may use a distributed ledger technology (e.g., blockchain of the Distributed Ledger Technology (DLT) network 133) as an unalterable log of the ML training platform 101's global events (e.g., proof 135 of the validity of the checkpoint claim 121). For example, DLT, such as a blockchain, is a decentralized system where records (blocks) are securely linked together via cryptographic hashes. Each block contains a cryptographic hash of the previous block, a timestamp, and transaction data, forming a chain that is resistant to alteration. The transaction data can record the events of the ML training platform 101 related to checkpointing.
(3) Provability: The resource owner 115 should be able to prove the validity of their checkpoint claim 121 to an arbitrary party (third-party verifiability). The resource owners 115 may rely on hardware capabilities such as cryptographic hardware and TEEs (e.g., TEE 119) such as but not limited to AMD Trust Zone, Intel SGX, NVIDIA Confidential Computing, and/or equivalent.

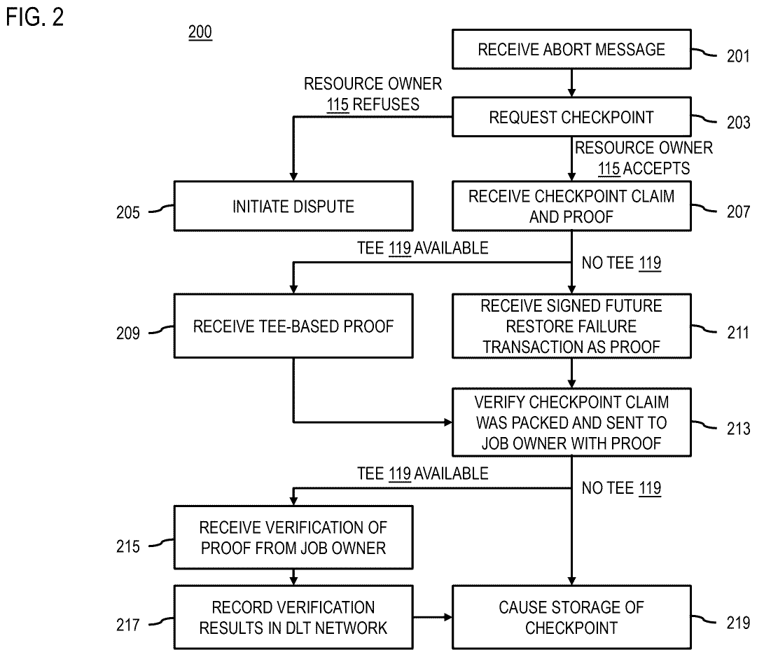

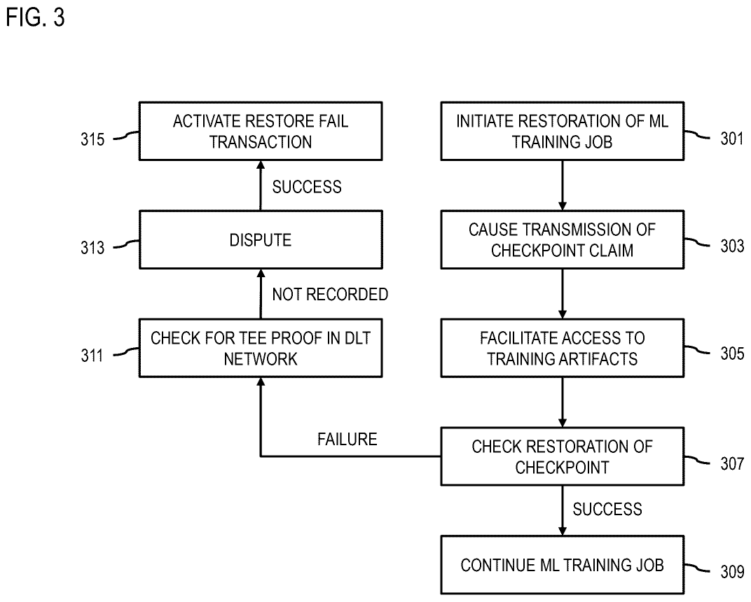

The various embodiments described herein ensure that system 100 satisfies the three properties listed above via two main sub-protocols: an ABORT protocol and a RESTORE protocol. A flowchart of the ABORT protocol is illustrated in FIG. 2, and a flowchart of the restore protocol is illustrated in FIG. 3. In one embodiment, each ABORT protocol run has at most one corresponding RESTORE protocol run. It is noted that a resource owner 115 can leave the ML training platform 101 anytime. In one embodiment, on leaving, the resource owner 115 forfeits all benefits they can earn by participating in it. In other words, this various embodiments described herein do not attempt to provide perfect availability of resource owners 115 to the decentralized ML training platform 101. Instead, the various embodiments described herein focus on the mitigating the security threat from the attackers exploiting the system for their direct benefits.

Throughout the description of various of the various embodiments, it is assumed that an identity layer 137 on top of the ml training platform 101 issues or otherwise provides the resource owners 115 and job owners 105 with cryptographic signatures, exchange keys, and encrypt messages. The various embodiments described herein are agnostic to the underlying cryptographic signature implementation, and can use any implementation known in the art depending on the application. For example, a quantum-resistant signature scheme can be used for encrypted messages to protect data when it is contemplated that the data may contain sensitive data such as but not limited to the intellectual property of job owners 105, personal data of users, etc.

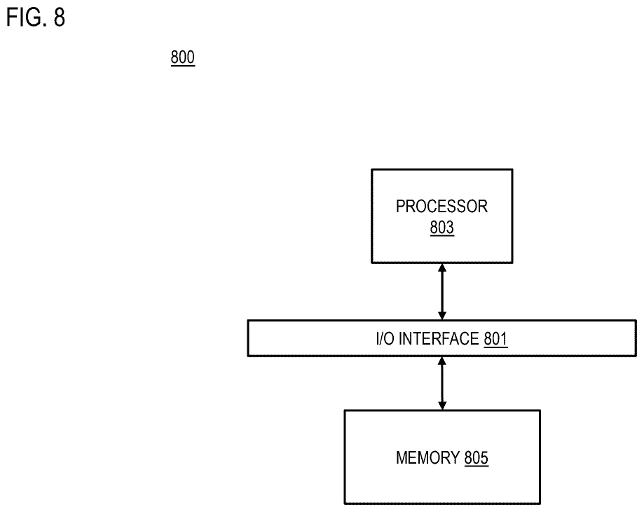

FIG. 2 is a flowchart of an ABORT protocol 200 for providing ML job checkpointing in trustless distributed training platforms, according to one example embodiment. In various embodiments, the ML training platform 101 may perform one or more portions of the protocol 200 and may be implemented in, for instance, a chip set including a processor and a memory as shown in FIG. 8. In addition or alternatively, one or more steps of the protocol 200 can be performed by the resource owner 115 system and/or job owner 105 system alone or in combination with the ML training platform 101. As such, the ML training platform 101, resource owner 115 system, and/or job owner 105 system can provide means for accomplishing various parts of the protocol 200, as well as means for accomplishing embodiments of other processes described herein in conjunction with other components of the system 100. Although the protocol 200 is illustrated and described as a sequence of steps, it is contemplated that various embodiments of the protocol 200 may be performed in any order or combination and need not include all of the illustrated steps.

In one embodiment, the ABORT protocol 200 starts with the resource owner 115 expressing their desire to reclaim their resources 117 by sending an “abort” message to the ML training platform 101. Accordingly, in step 201, the ML training platform 101 receives an abort message from a resource owner 115 system, the abort message relating to cancelling a ML training job 107 that is running, and the resource owner 115 system providing at least one compute resource 117 for performing the ML training job 107. In step 203, The ML training platform 101 then requests a checkpoint claim 121 from the resource owner 115. In one embodiment, the resource owner 115 can refuse the request for the checkpoint claim 121. On determining a refusal of the request for the checkpoint claim 121 by the resource owner 115, the ML training platform 101 can initiate a dispute protocol (e.g., described further below in the later sections) (step 205).

Upon accepting the checkpoint claim 121 request, the resource owner 115 packs the checkpoint into a checkpoint claim 121 as described above. For example, the checkpoint claim 121 comprises a progress pointer 123 in a training dataset 125 used in the ML training job 107 up to the cancelling of the ML training job 107, and training artifacts 127 comprising one or more model weights, one or more hyperparameters, or a combination thereof associated with the ML training job 107 up to the progress pointer 123. In one embodiment, the various embodiments described herein are agnostic to the format of checkpoint claim 121 and/or any of its elements such as but not limited to the training artifacts 127 (e.g., PyTorch). The resource owner 115 and job owner 105 can agree on the acceptable format depending on their needs.

Accordingly, in step 207, the ML training platform 101 receives a checkpoint claim from the resource owner system, the checkpoint claim relating to a checkpointing of the ML training job based on the cancelling of the ML training job. The ML training platform 101 also receives a proof 135 of the checkpoint claim 121 from the resource owner 115 system, the proof 135 comprising at least one of: a proof of execution of the ML training job generated within a TEE 119; or a creation of a future restore failure transaction on a DLT network 133, the future restore failure transaction configured to execute under a dispute protocol concerning a validity of the checkpoint claim 121. In one embodiment, the type of proof 135 is dependent on whether the resource owner 115 system operating its resource 117 in a TEE 119.

For example, the resource owner 115 then enters one of the subprotocols depending on the availability of TEEs 119. In step 209, if the confidential computing primitives of a TEE 119 are available, the resource owner 115 can construct a proof 135 of execution of the training job 107. By way of example, the confidential computing primitives of TEE 119 can include but is not limited to: (1) isolation—ensuring that the data and code for the ML training job 107 within the TEE 119 are isolated from the rest of the resource owner 115 system; (2) data integrity—encrypting data while it is in use to prevent unauthorized access; and/or (3) attestation—providing proof that the TEE 119 is using valid hardware, is correctly set up, and that the software for ML training in the TEE 119 is what is expected. This proof 135 advantageously provides computational efficiency to the system 100, allowing it to avoid reevaluating otherwise computation-intensive ML jobs (see the various embodiments of the dispute protocol for more details).

In one embodiment, when TEEs 119 are not available, the resource owner 115 relies on the capabilities of Distributed Ledger Technologies (e.g., blockchain of the DLT network 133) to create a future transaction, which guarantees payment to a recipient under certain future conditions. In other words, a DLT future transaction is type of transaction that is set to execute at a future date or under specific conditions. It leverages the decentralized and immutable nature of DLT to ensure that the transaction will be executed as intended without the need for intermediaries. In this embodiment, these future conditions relate to a future restore failure or success of the checkpoint claim 121. That is, if the checkpoint claim 121 results in a successful restoration of the corresponding ML training job 107, then success conditions are automatically initiated by the DLT network 133. Conversely, if the checkpoint claim 121 results in a failed restoration of the corresponding ML training job 107, then failure conditions are automatically initiated by the DLT network 133. In one embodiment, the conditions pertain to the decision of a dispute protocol committee relating to the validity or failure of the restoration of the ML training job 107 from the checkpoint claim 121. Accordingly, in step 211, the ML training platform 101 receives or otherwise accepts the future restore failure transaction that has been cryptographically signed by the resource owner 115 as the proof 135 of the checkpoint claim 121. For example, evidence of the future restore failure transaction can be read from the DLT network 133.

In one embodiment, to transmit the checkpoint claim 121 to the ML training platform 101 and/or the job owner 105, the resource owner 115 system packs and optionally compresses the checkpoint claim by including the elements previously described. For example, these elements include but are not limited to a progress pointer 123, training artifacts 127, resource owner signature 129, and/or any other related data. In one embodiment, the resource owner 115 then generates encrypts the checkpoint artifacts, and the encrypted checkpoint claim is then sent to the ML training platform 101 and/or job owner 105. In one embodiment, the resource owner 115 can generate a pointer to the storage of the training artifacts based on a hash of a cyphertext comprising one or more elements of the checkpoint claim, and also send this to the ML training platform 101 and/or job owner 105.

Accordingly, in embodiments in which the checkpoint claim 121 is sent to the job owner 105, the ML training platform 101 can verify that the checkpoint claim 121 was packed and sent to the job owner 105 with proof 135 (step 213). This verification protocol can depend on whether there are TEEs 119. For example, the DLT network 133 is used to record the checkpoint verification results when the TEEs 119 are present, and the job owner 105 admits that the checkpoint claim proof 135 verifies. In other words, the ML training platform 101 can perform a verification of the checkpoint claim 121, and then record a result of the verification in the DLT network 133. In one embodiment, the verification can be based on receiving a message from an owner 105 of the ML training job 107, the message admitting to a verification of the checkpoint claim (step 215). The ML training platform 101 can then record the message from the owner 105 in the DLT network 133 (step 217).

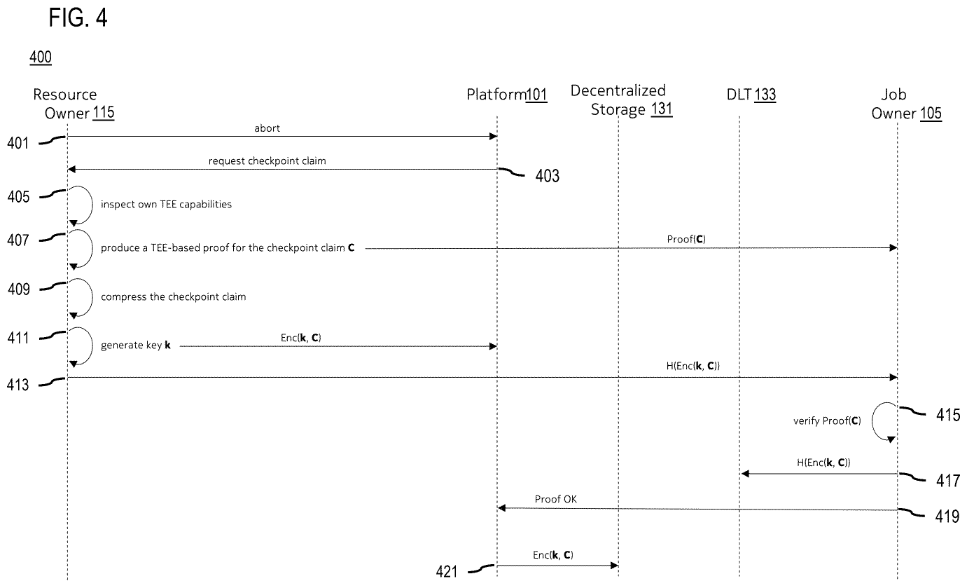

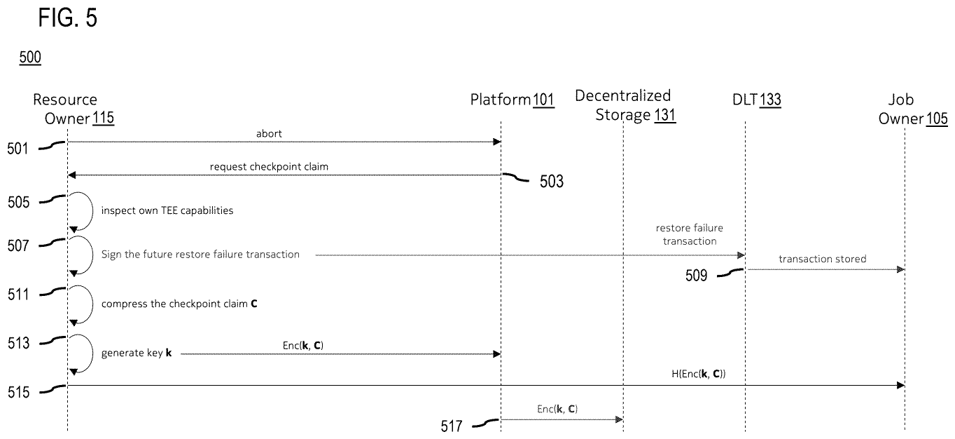

In step 219, the ML training platform 101 can then cause storage of the checkpoint claim 121 (e.g., in storage 131). In one embodiment, to ensure universal checkpoint recoverability, the system 100 can use distributed storage providers. For example, the ML training platform 101 may rely on decentralized file storage software like IPFS, traditional cloud object storage like Amazon S3, and/or any other equivalent data storage. In one embodiment, the system 100 can use any type of storage 131 to ensure that only encrypted ML artifacts can be shared with any external party. As previously described, in one embodiment, the ML training platform 101 and/or resource owner 115 can generate a pointer (e.g., a URL) to the storage of the training artifacts based on a hash of a cyphertext comprising one or more elements of the checkpoint claim. Once stored, the checkpoint claim 121 can be used to restore the checkpointed ML training job 107 at any future time. Additional details of the ABORT protocol 200 is provided further below with respect to FIGS. 4 and 5.

FIG. 3 is a flowchart of a restore protocol 300 for providing ML job checkpointing in trustless distributed training platforms, according to one example embodiment. In various embodiments, the ML training platform 101 may perform one or more portions of the protocol 300 and may be implemented in, for instance, a chip set including a processor and a memory as shown in FIG. 8. In addition or alternatively, one or more steps of the protocol 300 can be performed by the resource owner 115 system and/or job owner 105 system alone or in combination with the ML training platform 101. As such, the ML training platform 101, resource owner 115 system, and/or job owner 105 system can provide means for accomplishing various parts of the protocol 300, as well as means for accomplishing embodiments of other processes described herein in conjunction with other components of the system 100. Although the protocol 300 is illustrated and described as a sequence of steps, it is contemplated that various embodiments of the protocol 300 may be performed in any order or combination and need not include all of the illustrated steps.

In one embodiment, the RESTORE protocol 300 starts when a job owner 105 that has previously been involved in an ABORT protocol run wants to continue the ML training job 107 that has been aborted and checkpointed (e.g., according to protocol 200 of FIG. 2). Accordingly, in step 301, the ML training platform 101 initiates a restoration of the ML training job 107 that was previously aborted by a first resource owner 115 system. For example, the ML training platform 101 can present or track the presentation of the aborted ML training job 107 to a new resource owner 115 (e.g., also referred to as a second resource owner 115). The second resource owner 115 can accept the checkpointed ML training job 107 to be performed on their resources 117.

In step 303, the ML training platform 101 causes, at least in part, a transmission of a checkpoint claim 121 created by the first resource owner 115 system to a second resource owner 114 system, the checkpoint claim being associated with a proof comprising at least one of: a proof of execution of the ML training job up to a progress pointer in a training dataset, the proof of execution generated within a Trusted Execution Environment (TEE) of the first resource owner system; or a creation of a future restore failure transaction on a Distributed Ledger Technology (DLT) network, the future restore failure transaction configured to execute under a dispute protocol concerning a validity of the checkpoint claim. As part of this process, the ML training platform 101 requests the training artifacts 127 and/or any other elements of the corresponding checkpoint claim 121 from the job owner 105, which they can provide to the ML training platform 101 in the form of a special globally unique pointer (or URL) generated from the hash of the cyphertext that contains the checkpoint artifacts as described in the various embodiments of the ABORT protocol 200. It is noted that all information to construct such a unique pointer is provided by the resource owner 115 in the ABORT protocol 200.

In step 305, the ML training platform 101 facilitates an access of the second resource owner 115 to training artifacts 127 associated with the checkpoint claim 121. Facilitating access, for instance, comprises transmitting or otherwise providing this pointer or URL to the second resource owner 115 system. Using this pointer or URL, the job owner 105 can point the new resource owner 115 to the checkpoint claim 121 of the previous resource owner 115 that aborted the ML training job 107. In other words, the ML training platform 101 causes, at least in part, a transmission of a pointer to a storage location of the training artifacts 127 to the second resource owner 115. As noted, the pointer was generated based on a hash of a cyphertext comprising one or more elements of the checkpoint claim 121. The restoration of the ML training job 107 is then initiated based on the retrieved training artifacts and the progress pointer.

Sometimes, the new resource owner 115 may fail to restore the checkpoint claim 121. Accordingly, in step 307, the ML training platform 101 checks or verifies whether the restoration of the checkpoint claim 121 has succeeded or has failed. A successful restoration means that the process of resuming has been successful, and the training of the ML model 109 can continue from the progress pointer. In this case, in step 309, the second resource owner 115 continues with the ML training job 107. Conversely, a filed restoration means that the weights and hyperparameters of ML model 109 cannot be restored to its previous state. In such scenarios, in step 311, the ML training platform 101 can determine whether the TEE-based proof of execution of the previous training by the first resource owner 115 has been recorded in the DLT network 133. Recording of this TEE-based proof in the DLT network 133 indicates that that first resource owner 115 fulfil their training obligations but for some other reason than the fault of the first resource owner 115, the restoration has failed. Accordingly, there is no basis for initiate a dispute protocol against the first resource owner 115.

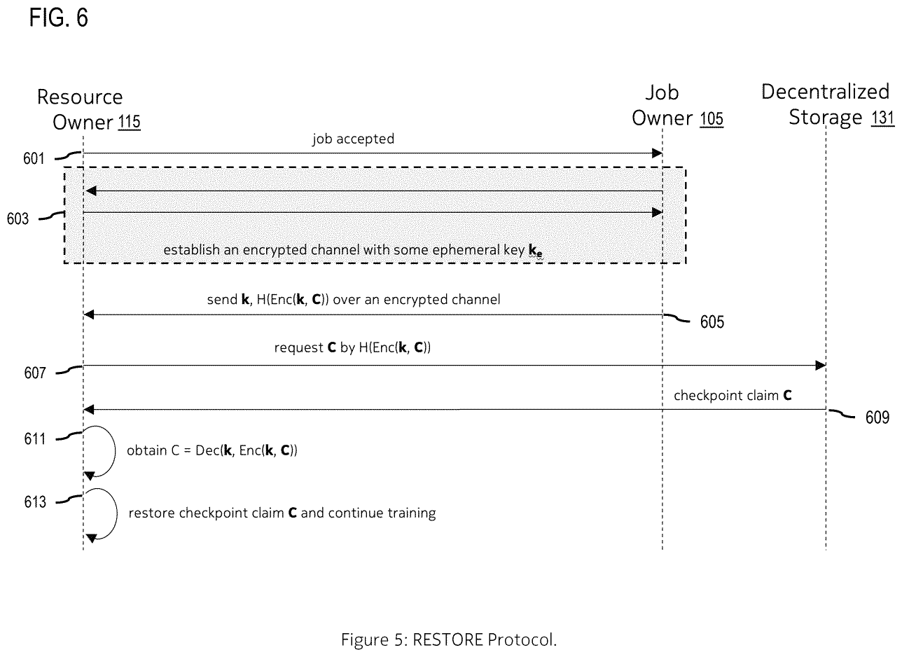

However, if no such TEE-based proof of execution is recorded in the DLT network 133, the dispute protocol can be activated. Details of the dispute protocol is provided in more detail further below. If the dispute protocol is successful against the first resource owner 115, then the corresponding restore fail transaction recorded in the DLT network 133 is automatically initiated to provide a remedy against the failure of the first resource owner 115. Additional details of the RESTORE protocol 300 is provided further below with respect to FIG. 6.

In this section, the sequence diagrams for the ABORT and RESTORE protocols and the description of the dispute protocol are provided with respect to FIGS. 4-6. It is noted that the checkpoint claim 121 cryptographic signature validation details is omitted in FIGS. 4-6 for simplicity, but that any signature validation scheme known in the art can be performed. In other words, the signature validation can be implemented in a standard way, e.g., according to the post-quantum advisory of standardization organizations. For example, in the US, NIST recommends the CRYSTALS-Dilithium scheme. In addition, the details of TEE-based proofs are also omitted in FIGS. 4-6 for simplicity, which establish a secure compute enclave on the hardware level by isolating compute unit registers and encrypting on-chip communication and memory. A specialized hardware cryptographic primitive is then employed to sign the computation results cryptographically. This cryptographic hardware element is attested to by the hardware vendor (e.g., Intel, NVIDIA, or equivalent) and can be verified by any interested party. Successfully completing an attestation session for a secure enclave establishes trust in the hardware unit based on trust in the vendor. Symmetric cryptographic key generation is also a standardized process whose details are omitted in FIGS. 4-6. Cryptographic algorithms for establishing secure communication channels, symmetric key generation, digital signatures on the checkpoint claims 121, and digital signatures to attest a secure enclave may differ. Nevertheless, in some embodiments, quantum-resistant approaches or any other equivalent approaches can be used according to the various embodiments described herein.

FIG. 4 is a sequence diagram for an ABORT protocol 400 using TEEs, according to one example embodiment. In other words, the example of FIG. 4 illustrates the ABORT protocol 400 when the aborting resource provider is TEE-enabled (e.g., has TEE capabilities). As shown in FIG. 4, the following parties are illustrated: the aborting resource owner 115, platform 101, decentralized (or distributed) storage 131, DLT network 133, and the job owner 105.

In the first step, the resource owner 115 sends the abort message to the platform 101 (process 401) and receives a checkpoint claim request in response (process 403). The abort message indicates a desire by the resource owner 115 to cancel a running ML training job, and the checkpoint claim request asks the resource owner 115 to create a checkpoint claim C comprising a progress pointer in the training dataset, training artifacts such as model weights and hyperparameters, along with proof of execution of the ML training job.

The resource owner 115 then inspects its TEE confidential computing capabilities (process 405). For example, the inspection results can be either TEE-enabled or non-TEE-enabled. FIG. 4 covers the scenario in which the inspection results indicate that the resource owner 115 is TEE-enabled (see FIG. 5 below for the scenario in which the resource owner is not TEE-enabled). At process 407, the TEE-enabled resource owner 115 generates a TEE-based proof for the checkpoint claim C (process 405), and sends it to the job owner 105 for validation.

At process 409, the resource owner 115 compresses the checkpoint claim. Upon completing these steps, at process 411, the resource owner 115 generates a symmetric cryptographic key k, encrypts the checkpoint artifacts (e.g., Enc(k, C) signifying encryption of checkpoint claim C using key k), and sends the cyphertext (Enc(k, C)) to the platform 101. In addition, at process 413, the resource owner 115 sends a hash of the cyphertext (H(Enc(K, C))) to serve as a pointer to the checkpoint artifacts on the decentralized storage 131.

At process 415, when the job owner 105 receives this data, they verify the proof of the checkpoint claim (Proof(C)), write the hash to the DLT 133 (process 417), and then notify the platform 101 that the proof is OK (process 419). At process 421, the platform 101 concludes the protocol by storing the cyphertext (Enc (k, C) in decentralized storage 131.

FIG. 5 is a signaling diagram for an ABORT protocol 500 when the resource owner has no TEE capabilities, according to one example embodiment. In one embodiment, the ABORT protocol 500 begins similarly to the ABORT protocol 400. In the first step, the resource owner 115 sends the abort message to the platform 101 (process 501) and receives a checkpoint claim request in response (process 503). The abort message indicates a desire by the resource owner 115 to cancel a running ML training job, and the checkpoint claim request asks the resource owner 115 to create a checkpoint claim C comprising a progress pointer in the training dataset, training artifacts such as model weights and hyperparameters, along with proof of execution of the ML training job.

The resource owner 115 then inspects its TEE confidential computing capabilities (process 505). For example, the inspection results can be either TEE-enabled or non-TEE-enabled. FIG. 5 covers the scenario in which the inspection results indicate that the resource owner 115 is not TEE-enabled (see FIG. 4 above for the scenario in which the resource owner is TEE-enabled).

The main difference is that the aborting resource owner 115 creates a future restore failure transaction and submits it to the DLT 133 (e.g., a blockchain) (process 507) in lieu of the TEE-based proof of ABORT protocol 400. At process 509, the resource owner 115 also notifies the job owner 105 of the creation of the future restore failure transaction in the DLT 133 to continue the ABORT protocol 500. It is noted that the future restore failure transactions can be implemented differently as described above, e.g., by including blockchain zero-knowledge contingent payments. The conditions of these future transactions are discussed in more detail below in the dispute protocol. Once the future transaction is created and the job owner is notified (e.g., using blockchain hooks), the resource owner continues the process similarly as in FIG. 4, except that the job owner 105 does not have a proof to verify.

At process 511, the resource owner 115 compresses the checkpoint claim. Upon completing these steps, at process 513, the resource owner 115 generates a symmetric cryptographic key k, encrypts the checkpoint artifacts (e.g., Enc(k, C) signifying encryption of checkpoint claim C using key k), and sends the cyphertext (Enc(k, C)) to the platform 101. In addition, at process 515, the resource owner 115 sends a hash of the cyphertext (H(Enc(k, C))) to serve as a pointer to the checkpoint artifacts on the decentralized storage 131. At process 517, the platform 101 concludes the protocol by storing the cyphertext (Enc (k, C) in decentralized storage 131.

FIG. 6 is a signaling diagram for a RESTORE protocol 600, according to one example embodiment. In this example, RESTORE protocol 600 involves: the new resource owner 115, job owner 105, and decentralized storage 131. The RESTORE protocol 600 starts with the new resource owner 115 notifying the job owner 105 that they have accepted the job (process 601). At process 603, the new resource owner 115 and job owner 105 then establish a secure communication channel and exchange the symmetric key (e.g., an ephemeral key kₑ), which the new resource owner 115 can use to decrypt the checkpoint artifacts from the decentralized storage 131. Besides the symmetric cryptographic key, the job owner 105 also sends the hash (H(Enc(k, C)) that the new resource owner 115 needs to locate the cyphertext of the checkpoint claim in the decentralized storage 131 (process 605). For example, the new resource owner 115 requests the checkpoint claim from the decentralized storage 131 using the hash (H(Enc(k, C)) as the pointer to the storage location in decentralized storage 131 (process 607). At process 609, the decentralized storage 131 returns the requested checkpoint claim to the new resource owner 115. In one embodiment, the checkpoint claim is returned in encrypted form. Accordingly, at process 611, the new resource owner 115 uses the key k to decrypt the encrypted checkpoint claim. The RESTORE protocol 600 ends when the new resource owner 115 starts executing the checkpointed training task from the checkpoint progress pointer and training artifacts obtained from the decentralized storage 131.

As previously discussed, the system 100 can enter a dispute protocol in at least three distinct scenarios:
(1) The resource owner 115 refuses to provide a checkpoint claim during the ABORT protocol. As there is no method to prove that the resource owner 115 has performed proper computation in this case, the dispute protocol declares the failure of the resource owner 115, ensuring that the resource owner 115 in question does not receive any value in return. For instance, if the ML training platform 101 is designed for job owners 105 to pay the resource owners 115 when the job 107 is complete, declaring the failure of the resource owner 115 would mean that the job owner 105 is not obliged to pay.
(2) Upon receiving the checkpoint claim proof 135 from a TEE-enabled resource owner 115 during the ABORT protocol, the proof verification fails at the job owner 105's side. The job owner 105 may then notify the ML training platform 101 of the failure and request it to return the error to the resource owner 115. The ML training platform 101 will declare an error if the resource owner 115 agrees that the proof 135 is invalid. In general, the failure of the proof verification may mean two distinct things: (a) the checkpoint proof 135 is indeed invalid; and (b) the checkpoint proof 135 is valid, but the job owner 105 is malicious, trying to avoid declaring the success of the resource owner 115 (e.g., this malicious behavior can benefit the job owner 105 if they convince the trusted platform component and avoid transferring the value to the resource owner 115).

In one embodiment, to address the second case, the ML training platform 101 can manage a committee of independent verifiers to verify the checkpoint proof 135 and decide if the situation falls into the first or the second category above. If the committee rules the scenario belongs to the second case, the malicious job owner 105 can be penalized. In one embodiment, the checkpoint proof verification committee can be reimbursed from the funds obtained by penalizing malicious job owners 105.

In other words, the ML training platform 101 can receive a message or equivalent indication from an owner 105 of the ML training job 107, the message indicating a verification failure of the proof 135 provided by resource owner 115. The ML training platform then refers the matter to the committee of independent verifiers. It is contemplated that the committee can use any means to determine the malicious party (e.g., the resource owner 115 or the job owner 105). For example, the committee can evaluate the message indicating the verification failure of the proof 135 based on a deterministic comparison, a probabilistic comparison, or a combination thereof of the training artifacts.

A deterministic comparison, for instance, can be performed by asking the aborting resource owner 115 to provide the seeds for the sources of randomness (PRNG). When the committee seeds the PRNGs with known seeds, the resulting weights matrix will be the same as when the aborting resource owner 115 did it if the resource owner 115 completed the task as stated. A probabilistic comparison, for instance, can use a known similarity metric between the weights matrices (e.g., cosine similarity, Frobenius norm, Kullback-Leibler, Pearson score, etc.). The probability of having two similar weight matrices corresponding to significantly different stages of training is low.

Other examples include but are not limited to inspecting the checkpoint data and comparing with similar models. For example, inspecting the checkpoint data can include but is not limited to: (a) checking the epoch/iteration number—a checkpoint claiming to be near completion with an epoch/iteration number below a threshold value can indicate false training claims; (b) model weights—comparing the weights in the checkpoint to the initial weights of the model can be performed (e.g., checkpoint weights that are very similar to the initial values suggest minimal training has been performed); and/or (c) loss and metrics—analyze the loss and other metrics recorded in the checkpoint (e.g., if the values are not significantly improved from the initial values, it indicates insufficient training). Another approach involves comparing with similar models such as but not limited to: (a) benchmarking—compare the performance of the model loaded from the checkpoint with known benchmarks for similar models trained on the same dataset (e.g., significant discrepancies might indicate a problem with the checkpoint); and/or (b) other checkpoints—If there is access to other checkpoints from the same training process, compare the data and metrics to see if there are any inconsistencies or sudden jumps in progress. It is noted that these means for evaluating a checkpoint is provided by way of illustration and not as limitations. It is contemplated that any other equivalent evaluation means can be used according to the various embodiments described herein.
(3) During the RESTORE protocol, the restoration of the checkpoint fails at the new resource owner 115, and the hash of the checkpoint claim is not written to DLT during the ABORT protocol. This scenario signals that the previous resource owner 115 was not TEE-enabled, and thus has not engaged in proving the validity of their checkpoint claim during the ABORT protocol. In this case, the job owner 105 will begin the checkpoint claim reload process and will observe either one of the following:
(a) Invalid checkpoint claim. The job owner 105 then files a complaint to the trusted checkpoint claim committee and submits the checkpoint claim 121 to the committee for resolution. The committee can resolve the job owner 105's claim using one of the protocols described below. The committee members are reimbursed for their work from the funds of the losing party. If the job owner 105 wrongly accused a resource owner 115, the job owner 105 will pay the committee. If the job owner 105's complaint was sound, the future restoration failure transaction (e.g., providing for a future reimbursement) signed by the resource owner 115 before issuing the checkpoint claim 121 is activated to reimburse the job owner 105.
(b) Valid checkpoint claim.

As described above, in one embodiment, the system 100 includes two committees: (1) the checkpoint proof verification committee is involved in scenario 2 of the dispute protocol; and (2) the checkpoint claim reevaluation committee from scenario 3 of the dispute protocol.

In one embodiment, trust in both committees can be established in two distinct ways:
(1) Via attesting their TEE capabilities. A single TEE-enabled machine that can prove they execute the exact code they were given (e.g., checkpoint claim reevaluation or checkpoint claim proof from a different TEE) is enough.
(2) Via honest majority. When there are no TEE-enabled committees, we can fall back to the decentralized nature of the ML training platform 101. Under the assumption that a randomly selected committee will yield a majority-honest group, we can challenge all committee members with the same task (e.g., checkpoint claim reevaluation or checkpoint claim proof) and decide by majority voting. In this case, at least three or more committee members are involved.

Returning to FIG. 1, in one example, the components of the system 100 may communicate over one or more communications networks 111 that includes one or more networks such as a data network, a wireless network, a telephony network, or any combination thereof. It is contemplated that the communications network 111 may be any local area network (LAN), metropolitan area network (MAN), wide area network (WAN), a public data network (e.g., the Internet), short range wireless communications network, or any other suitable packet-switched network, such as a commercially owned, proprietary packet-switched network, e.g., a proprietary cable or fiber-optic network, and the like, or any combination thereof. In addition, the communications network 111 may be, for example, a cellular telecom network and may employ various technologies including enhanced data rates for global evolution (EDGE), general packet radio service (GPRS), global system for mobile communications (GSM), Internet protocol multimedia subsystem (IMS), universal mobile telecommunications system (UMTS), worldwide interoperability for microwave access (WiMAX), Long Term Evolution (LTE) networks, 5G/3GPP (fifth-generation technology standard for broadband cellular networks/3rd Generation Partnership Project) or any further generation, code division multiple access (CDMA), wideband code division multiple access (WCDMA), wireless fidelity (Wi-Fi), wireless LAN (WLAN), Bluetooth®, UWB (Ultra-wideband), Internet Protocol (IP) data casting, satellite, mobile ad-hoc network (MANET), and the like, or any combination thereof.

In one example, the system 100 or any of its components may be a platform with multiple interconnected components (e.g., a distributed framework). The system 100 and/or any of its components may include multiple servers, intelligent networking devices, computing devices, components, and corresponding software for spatial-temporal authentication. In addition, it is noted that the system 100 or any of its components may be a separate entity, a part of the one or more services, a part of a services platform, or included within other devices, or divided between any other components.

By way of example, the components of the system 100 can communicate with each other and other components external to the system 100 using well known, new or still developing protocols. In this context, a protocol includes a set of rules defining how the network nodes, e.g. the components of the system 100, within the communications network interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically affected by exchanging discrete packets of data. The packets typically comprise (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

The processes described herein for providing ML job checkpointing in trustless distributed training platforms may be advantageously implemented via software, hardware (e.g., general processor, memory, input/output interface, etc.), firmware, circuitry, or a combination thereof. Such exemplary hardware for performing the described functions is detailed below.

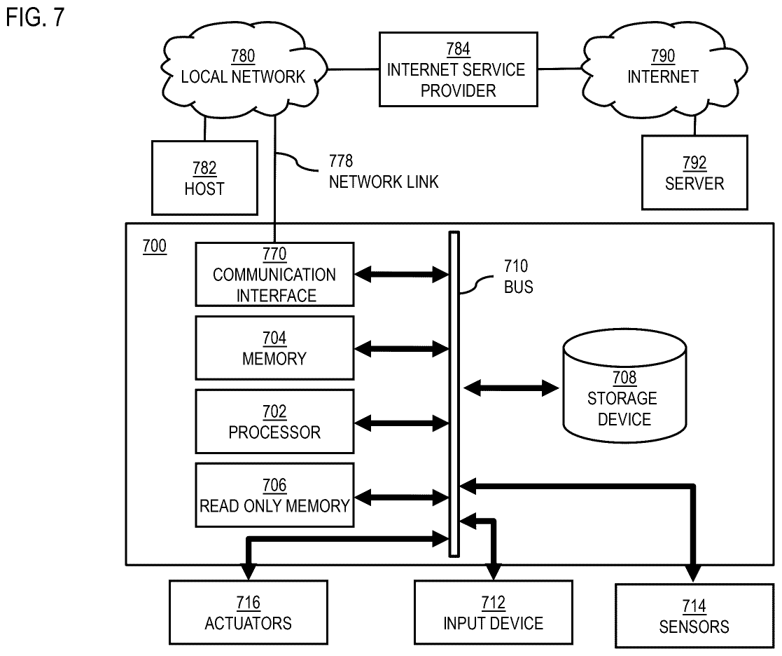

FIG. 7 illustrates an example computer system 700 upon which embodiments of the invention as described with the processes described herein may be implemented. The computer system 700 is programmed (e.g., via computer program code or instructions) to provide ML job checkpointing in trustless distributed training platforms as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 710 includes one or more parallel conductors of information so that information is transferred quickly among devices coupled to the bus 710. One or more processors 702 for processing information are coupled with the bus 710.

A processor 702 performs a set of operations on information as specified by computer program code related to providing ML job checkpointing in trustless distributed training platforms. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations includes bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

The computer system 700 also includes a memory 704 coupled to bus 710. The memory 704, such as a random access memory (RAM) or other dynamic storage device, stores information including processor instructions for providing ML job checkpointing in trustless distributed training platforms. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for providing ML job checkpointing in trustless distributed training platforms, is provided to the bus 710 for use by the processor from an external input device 712, such as a keyboard containing alphanumeric keys operated by a human user, or one or more sensors. In one embodiment, the computer system 700 includes or otherwise has access to one or more sensors 714 which detect conditions in its vicinity and transforms those detections into physical expression compatible with the measurable phenomenon used to represent information in the computer system 700. Examples of sensors 714 include but are not limited to cameras, Lidar, positioning sensors, gyroscopes, accelerometers, and/or the like. Other external devices coupled to bus 710, include one or more actuators 716. By way of example, an actuator is a device that converts electrical signals (e.g., control signals) into physical actions, such as movement, rotation, or force. In a mobile robot or equivalent drivetrain, an actuator 716 can be used to control the wheels that enable the robot to perform various maneuvers. For example, an actuator 716 can regulate the speed and direction of the wheels. Actuators 716 can be powered by different sources, such as but not limited to electricity, pneumatic pressure, or hydraulic fluid. Some examples of actuators 716 include but are not limited to motors, solenoids, cylinders, and servos. In some embodiments, for example, in embodiments in which the computer system 700 performs all functions automatically without human input, one or more of external input device 712, display device 714 and pointing device 716 is omitted. In various embodiments, the computer system 700 is further connected via the bus 710 to a one or more camera device, flash device or Lidar device.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general, the coupling is with a network link 778 that is connected to a local network 780 to which a variety of external devices with their own processors are connected. In certain embodiments, the communications interface 770 enables connection to the communications network 111 for providing ML job checkpointing in trustless distributed training platforms.

The term computer-readable medium is used herein to refer to any medium that participates in providing information to processor 702, including instructions for execution. Such a medium may take many forms, including, but not limited to, non-volatile media, volatile media and transmission media. Non-volatile media include, for example, optical or magnetic disks, such as storage device 708. Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, any solid state medium, any magnetic medium, any optical medium, any physical medium, a RAM, any other memory chip, a carrier wave, or any other medium from which a computer can read.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communications network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of the system 100 can be deployed in various configurations within other computer systems, e.g., host 782 and server 792.

FIG. 8 illustrates a chip set 800 upon which embodiments of the invention, for example, the components of system 80 may be implemented. The chip set 800 is programmed to provide ML job checkpointing in trustless distributed training platforms as described herein. By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 800 includes a communication mechanism such as an input/output (I/O) interface 801 for passing information among the components of the chip set 800 and to external devices (e.g., sensors and/or actuators of a robot, transmitters/receivers for signaling a vehicle/robot/drivetrain or component thereof, etc.). A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the I/O interface 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to provide ML job checkpointing in trustless distributed training platforms. The memory 805 also stores the data associated with or generated by the execution of the inventive steps.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. An apparatus comprising:
at least one processor, and
at least one memory storing instructions that, when executed by the at least one processor, cause the apparatus at least to perform:
receiving an abort message from a resource owner system, the abort message relating to cancelling a Machine Learning (ML) training job that is running, and the resource owner system providing at least one compute resource for performing the ML training job;
receiving a checkpoint claim from the resource owner system, the checkpoint claim relating to a checkpointing of the ML training job based on the cancelling of the ML training job;
receiving a proof of the checkpoint claim from the resource owner system, the proof comprising at least one of:
a proof of execution of the ML training job generated within a Trusted Execution Environment (TEE); or
a creation of a future restore failure transaction on a Distributed Ledger Technology (DLT) network, the future restore failure transaction configured to execute under a dispute protocol concerning a validity of the checkpoint claim; and
causing, at least in part, a storage of training artifacts of the ML training job based on the proof.

2. The apparatus of claim 1, wherein the checkpoint claim comprises:
a progress pointer in a training dataset used in the ML training job up to the cancelling of the ML training job; and
the training artifacts comprising one or more model weights, one or more hyperparameters, or a combination thereof associated with the ML training job up to the progress pointer.

3. The apparatus of claim 1, wherein the apparatus is caused to further perform:
performing a verification of the checkpoint claim; and
recording a result of the verification in the DLT network.

4. The apparatus of claim 1, wherein the apparatus is caused to further perform:
receiving a message from an owner of the ML training job, the message admitting to a verification of the checkpoint claim; and
recording the message in the DLT network.

5. The apparatus of claim 1, wherein the apparatus is caused to further perform:
receiving a message from an owner of the ML training job, the message indicating a verification failure of the proof.

6. The apparatus of claim 5, wherein the apparatus is caused to further perform:
evaluating the message indicating the verification failure of the proof based on a deterministic comparison, a probabilistic comparison, or a combination thereof of the training artifacts.

7. The apparatus of claim 1, wherein the apparatus is caused to further perform:
generating a pointer to the storage of the training artifacts based on a hash of a cyphertext comprising one or more elements of the checkpoint claim.

8. The apparatus of claim 1, wherein the training artifacts are stored in a decentralized file storage.

9. An apparatus comprising:
at least one processor, and
at least one memory storing instructions that, when executed by the at least one processor, cause the apparatus at least to perform:
initiating a restoration of a Machine Learning (ML) training job, the ML training job being previously aborted by a first resource owner system;
causing, at least in part, a transmission of a checkpoint claim created by the first resource owner system to a second resource owner system, the checkpoint claim being associated with a proof comprising at least one of:
a proof of execution of the ML training job up to a progress pointer in a training dataset, the proof of execution generated within a Trusted Execution Environment (TEE) of the first resource owner system; or
a creation of a future restore failure transaction on a Distributed Ledger Technology (DLT) network, the future restore failure transaction configured to execute under a dispute protocol concerning a validity of the checkpoint claim;
facilitating an access of the second resource owner to training artifacts associated with the checkpoint claim,
wherein the restoration of the ML training job is initiated based on the training artifacts and the progress pointer.

10. The apparatus of claim 9, wherein the apparatus is caused to further perform:
causing, at least in part, a transmission of a pointer to a storage location of the training artifacts to the second resource owner, wherein the pointer was generated based on a hash of a cyphertext comprising one or more elements of the checkpoint claim.

11. The apparatus of claim 9, wherein the checkpoint claim comprises:
the progress pointer; and
the training artifacts comprising one or more model weights, one or more hyperparameters, or a combination thereof associated with the ML training job up to the progress pointer.

12. The apparatus of claim 9, wherein the future restore failure transaction is signed by an owner of the ML training job based on the restoration of the ML training job, and wherein the signed future restore failure transaction is recorded in the DLT network.

13. The apparatus of claim 12, wherein the signed future restore failure transaction is activated based on a successful dispute associated with a failure of the restoration.

14. An apparatus comprising:
at least one processor, and
at least one memory storing instructions that, when executed by the at least one processor, cause the apparatus at least to perform:
generating a checkpoint claim, wherein the checkpoint claim relates a checkpointing of a Machine Learning (ML) training job that is running;
generating a proof of the checkpoint claim, the proof comprising at least one of:
a proof of execution of the ML training job generated within a Trusted Execution Environment (TEE); or
a creation of a future restore failure transaction on a Distributed Ledger Technology (DLT) network, the future restore failure transaction configured to execute under a dispute protocol concerning a validity of the checkpoint claim; and
causing, at least in part, a transmission of the proof of the checkpoint claim.

15. The apparatus of claim 14, wherein the apparatus is caused to further perform:
causing, at least in part, a transmission of an abort message, the abort message relating to cancelling the ML training job; and
receiving a request for the checkpoint claim based on the abort message.

16. The apparatus of claim 14, wherein the checkpoint claim comprises:
a progress pointer in a training dataset used in the ML training job up to a cancelling of the ML training job; and
training artifacts of the ML training job comprising one or more model weights, one or more hyperparameters, or a combination thereof associated with the ML training job up to the progress pointer.

17. The apparatus of claim 16, wherein the training artifacts are stored based on the proof.

18. The apparatus of claim 14, wherein a verification of the checkpoint claim is performed, and wherein a result of the verification is stored in the DLT network.

19. The apparatus of claim 14, wherein a message from an owner of the ML training job is received, the message indicating a verification failure of the proof.

20. The apparatus of claim 19, wherein the message indicating the verification failure of the proof is evaluated based on a deterministic comparison, a probabilistic comparison, or a combination thereof of the training artifacts.
